(19) United States
(12) Patent Application Publication
(10) Pub. No.: US 2025/0216131 A1
(43) Pub. Date: Jul. 3, 2025

(54) REFRIGERANT PORT ADAPTER

(71) Applicant: Airsept, Inc., Atlanta, GA (US)

(72) Inventor: Aaron Becker, Atlanta, GA (US)

(21) Appl. No.: 19/006,075

(22) Filed: Dec. 30, 2024

Related U.S. Application Data
(60) Provisional application No. 63/615,729, filed on Dec. 28, 2023.

(51) Int. Cl. F25B 45/00

(52) U.S. Cl. CPC F25B 45/00; F25B 2345/006

(57) ABSTRACT

A refrigerant port adapter includes an adapter body configured to fit over a first port. The adapter body is secured to the first port. A fluid-tight seal is provided between the first port and the adapter. The adapter body includes a valve section that contains a valve core and is configured as an R-1234yf port, either a high-pressure side or a low-pressure side R-1234yf port.

### RELATED APPLICATION

This Application is a Nonprovisional of and claims the benefit of priority of U.S. Provisional Application 63/615,729 file Dec. 28, 2023, the entire contents of which are incorporated herein by this reference.

### FIELD OF THE INVENTION

This invention relates generally to refrigerants, and, more particularly, to an adapter for coupling a first refrigerant connector (e.g., a connector for R-1234yf refrigerant) to a port configured for another type of refrigerant (e.g., R-134a).

### BACKGROUND OF THE INVENTION

R-1234yf refrigerants for mobile air-conditioning systems have been widely used in passenger vehicles the past several years, but they are just now gaining traction in medium and heavy-duty commercial vehicles. Environmental policies are driving the shift to R-1234yf, which has a Global Warming Potential (GWP) of <1 compared to R-134a's GWP of 1,300.

A significant difference is due to R-1234yf being a hydrofluoroolefin (HFO), a molecule that has a very short-lived atmospheric life. While hydrofluorocarbon (HFC) R-134a remains in the atmosphere an average of 12 years, R-1234yf's atmospheric lifetime averages a mere 11 days.

The service port is an orifice located on the air conditioning system. It typically includes a body configured for quick connect coupling. It contains a valve core that controls the flow of refrigerant. As a precaution, service ports for R-1234yf are different in dimension than service ports for R-134a. The difference reduces risk of filling a system designed for one refrigerant with another refrigerant.

There may be a desire to fill an R-134a system with R-1234yf. The desire may be driven by environmental concerns and/or the cost and/or availability. An R-134a system is substantially the same as an R-1234yf system, except for different port dimensions and the addition of an inline heat exchanger typically located within the accumulator in R-1234yf systems. Such a heat exchanger may be added to an R-134a system. Even without such a heat exchanger, an R-134a system may operate with R-1234yf refrigerant, albeit with less cooling capacity.

Heretofore, to couple conventional R-1234yf supply and servicing equipment to an R-134a system, the R-134a ports must be replaced. Such replacement adds material and labor costs and a new potential point of failure. An adapter is needed to efficiently convert existing R-134a ports to R-1234yf ports.

The invention is directed to overcoming one or more of the problems and solving one or more of the needs as set forth above.

### SUMMARY OF THE INVENTION

To solve one or more of the problems set forth above, in an exemplary implementation of the invention, a refrigerant port adapter is provided. The refrigerant port adapter ‘includes an adapter body configured to fit over a first port. The adapter body is secured to the first port. A fluid-tight seal is provided between the first port and the second port. A second port extends from the adapter body. The second port is not a separate port, but rather a section of the adapter body that contains a valve core and is configured structurally as an R-1234yf port, as a high-pressure side or a low-pressure side R-1234yf port. The second port fluidly communicates with the first port, which may be an R-134a port.

Each embodiment includes retention, sealing and spacing components. The retention component(s) comprise(s) a retention mechanism that secures the adapter body to the first port and prevents unintended removal of the adapter body from the first port. The first port is at least partially received in the adapter body. In one embodiment the retention components include external threads at a base of the adapter body, a nut with a central aperture sized to receive the adapter body. The nut is internally threaded to threadedly engage the external threads at the base of the adapter body. A retaining ring engages the neck of the first port and occupies space between the interior of the base of the adapter body and the neck of the first port. The retaining ring is a split ring. When installed on the neck of the first port it forms a band around the neck. The retaining ring cannot pass through the central aperture of the nut.

In an alternative embodiment, in lieu of the threads formed directly on the exterior of the adapter body, a separate component, such as a ring, may feature threads. The ring may be sized to snugly surround a portion of the outer surface of the adapter body. The ring may be removable. A tubular feature with threads may be integrally formed with and extend from the ring. The threads allow a nut or other component with mating threads to threadedly engage the ring.

The spacing component is a bushing-like structure that occupies space between the interior surface of the adapter body and the exterior surface of a portion of the first port received in the adapter body. The spacing component resists angular movement of the adapter body relative to the first port. The spacing component may also serve as a seal.

Additionally, one or more elastomeric seals may be provided to ensure a leak-free coupling. In one embodiment the seal comprises an O-ring disposed between the free open end of the first port and an adjacent interior structure of the adapter body. The adjacent interior structure may comprise an annular flange section.

In another embodiment, the body is adapted to be secured, with a retaining ring, to a received portion of the first port. In this embodiment, the body includes a plurality spaced apart longitudinal grooves. The grooves extend from the base of the body. The grooves extend to a point between the valve section of the body and the base of the body. The groves end at a radiused terminus. The grooves may be equal in length, evenly spaced and parallel. Each pair of adjacent grooves defines a finger therebetween. The finger may exhibit flexibility in the manner of a cantilever beam. An annular flange projects outwardly from the outer surface of the body, between the base of the body and the groove terminus. The outer diameter of the body between the base and the flange is less than the outer diameter of the body between the flange and the groove terminus.

The retaining ring is a solid ring, with a plurality of inward radially extending tabs extending from one edge. Each tab is sized to fit in a groove. The inner diameter of the retaining ring (excluding the tabs), is about equal to the outer diameter of the annular flange. When the ring is positioned around the annular flange, the ring may be rotated for the tabs to be positioned between grooves and abut and/or exert force against the fingers, between the base and the annular flange. A plurality of projections may extend from the edge of the ring opposite the tabbed edge. These projections abut the outer surface of the body, between the annular flange and the groove terminus, when the ring is installed.

A seal occupies interior space of the body, in the engagement section of the body, between the interior surface of the body and the received portion of the first port. The seal ensures a leak-free coupling. The seal may be inserted into the space by slightly deflecting the fingers to enlarge the opening at the base. After the seal is seated in the body, the fingers return to their undeflected position. When installed, the retaining ring prevents such deflection of the fingers.

In one embodiment, the refrigerant port adapter is designed with an adapter body that includes a valve section and an engagement section. The engagement section is crafted to accommodate at least a portion of a first refrigerant port. The valve section contains a valve core, threadedly engaged in the valve section. The valve section is equipped with an exterior that allows for quick connect coupling and valve core actuation, facilitating a seamless connection process. Additionally, a resilient seal within the engagement section ensures a fluid-tight seal between the engagement section and the first refrigerant port, enhancing the system's reliability. To prevent the adapter body from being removed from the first refrigerant port, a retainer engages at least a portion of the exterior of the engagement section.

The engagement section of the adapter is designed with an open end and features multiple spaced-apart grooves that create flexible fingers. These fingers can flex outwardly, and the retainer comprises a movable ring that, when installed, surrounds a portion of the fingers to prevent their outward deflection. The engagement section's exterior includes a protruding collar, with grooves extending from the open end to their terminus, ensuring the ring fits tightly around the collar. The number of grooves can range from at least five to seven, and these grooves are evenly spaced apart. The ring itself is designed with groove tabs that align and slide within the grooves, and stop tabs that impede the ring's sliding movement beyond the collar.

The fluid-tight seal in the adapter is cup-shaped with a central aperture, featuring a base and an annular flange extending from the base. The central aperture has a diameter less than the end of the first refrigerant port's portion, providing a snug fit. The sidewall of the seal includes a free end defining an opening, with the internal diameter at the opening being greater than that adjacent to the base. The adapter body is constructed from brass, ensuring durability and reliability. Additionally, the ring in the engagement section is made of aluminum, contributing to the overall lightweight and robust design of the refrigerant port adapter.

### BRIEF DESCRIPTION OF THE DRAWINGS

The foregoing and other aspects, objects, features, and advantages of the invention will become better understood with reference to the following description, appended claims, and accompanying drawings, where:

FIG. 1 is a high-level schematic of an exemplary refrigerant port adapter according to principles of the invention;

FIG. 2 is a perspective view of an exemplary retaining ring for a refrigerant port adapter according to principles of the invention;

FIG. 3 is a perspective view of an exemplary O-ring for a refrigerant port adapter according to principles of the invention;

FIG. 4 is a section view of an exemplary O-ring for a refrigerant port adapter according to principles of the invention;

FIG. 5 is a perspective view of an exemplary sleeve for a refrigerant port adapter according to principles of the invention; and

FIG. 6 is a perspective view of an exemplary adapter body for a refrigerant port adapter according to principles of the invention; and

FIG. 7 is an exploded perspective view of another exemplary refrigerant port adapter according to principles of the invention;

FIG. 8 is an assembled section view of the exemplary refrigerant port adapter of FIG. 6 according to principles of the invention;

FIG. 9 is a first view of the exemplary retaining ring for the refrigerant port adapter of FIG. 6 according to principles of the invention;

FIG. 10 is a second view, opposite the first view of FIG. 9, of the exemplary retaining ring for the refrigerant port adapter of FIG. 6 according to principles of the invention;

FIG. 11 is a perspective view of the exemplary retaining ring for the refrigerant port adapter of FIG. 6 according to principles of the invention;

FIG. 12 is a side view of the adapter body for the refrigerant port adapter of FIG. 6 according to principles of the invention;

FIG. 13 is a side section view of the adapter body for the refrigerant port adapter of FIG. 6 according to principles of the invention;

FIG. 14 is a first view of a seal for the refrigerant port adapter of FIG. 6 according to principles of the invention; and

FIG. 15 is a side section view of the seal for the refrigerant port adapter of FIG. 6 according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects, or proportions as shown in the figures.

### DETAILED DESCRIPTION

An exemplary refrigerant port adapter according to principles of the invention includes an adapter body configured to fit over a first port. The adapter body is secured to the first port. A fluid-tight seal is provided between the first port and the second port. A second port extends from the adapter body. The second port, which may be an R-1234yf port, fluidly communicates with the first port, which may be an R-134a port.

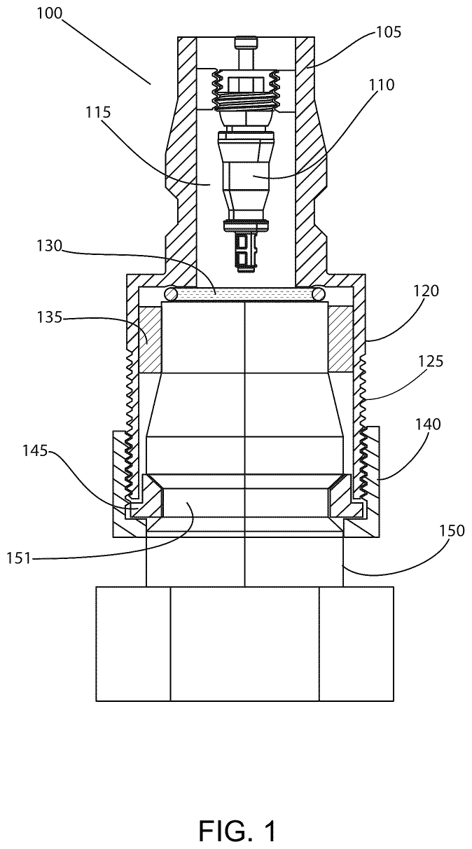

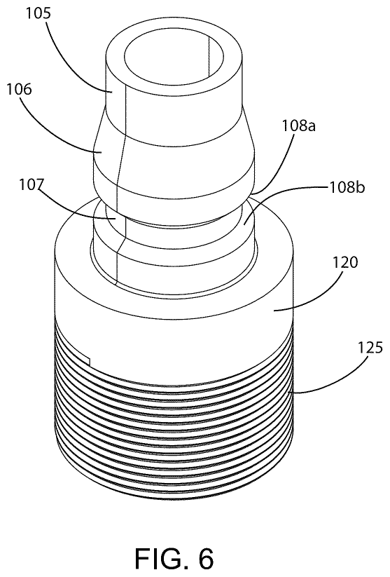

FIG. 1 is a high-level schematic of an exemplary refrigerant port adapter 100 according to principles of the invention. The adapter 100 includes an adapter body, as also shown in FIG. 6. The exterior of the adapter body 105 includes an annular flange 106 with chamfered (e.g., beveled) edges 108a, 108b. The flange 106 is formed between a tubular tip 109 and a tubular neck 107. The exterior of the port 150 received by the adapter body 105 is similarly configured with an annular flange having chamfered edges between a tubular tip and neck, except that the dimensions are different.

The adapter body 105 includes a base 120. The base 120 is a tubular portion sized to receive the port 150 at least up to the neck of the port 150. The exterior surface of the base 120 is threaded, from an open end to a point between a closed end and the open end of the base 120. The threads 125 are configured to threadedly engage threads of a nut 140.

The nut 140 engages the threads 125 of the base 120. The nut 140 is disposed adjacent to the neck of the port 150. The nut 140 includes a central opening sized to receive the annular flange of the port 150.

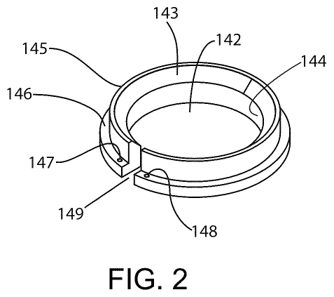

A retaining ring 145 engages the neck of the port 150. The retaining ring 145 prevents movement of the nut 140 beyond the neck 145 of the port 150. As shown in FIG. 2, The retaining ring 145 is a split ring. A gap 149 defines the split. A pair of engagement holes 147, 148 are provided near the free ends for spreading the ends of the ring apart using a tool. An exterior annular flange 146 is provided along the bottom edge of the retaining ring 145. The interior of the retaining ring 145 includes a vertical edge 144 leading to a chamfered edge 143. The vertical edge 144 and chamfered edge 143 fit snugly within the neck of the port 150. The annular flange 146 prevents movement of the nut 150 past the neck of the port 150.

The retaining ring 145 is spread open to install or remove. When spreading force is removed, the retaining ring 145 springs back to its undeformed state, as conceptually shown in FIG. 2. In the undeformed state, the retaining ring 145 is sized to fit between the neck of the port 150 and the base 120 and nut 140. The interior of the retaining ring 145 includes a central opening 142 that has an undeformed diameter that is about equal to the outer diameter of the neck of the port 150. The outer diameter of the top of the retaining ring 145 is about equal to or slightly less than the inner diameter of the base 120. The outer diameter of the flange 146 is about equal to or slightly less than the inner diameter of the nut 140. Additionally, the outer diameter of the flange 146 is greater than the central opening of the nut 140 and greater than the inner diameter of the base 120. When installed, the top of the retaining ring 145 is disposed between the base 120 and neck of the port 120, and the annular flange 146 is abuts the open end of the base 120 and is disposed between the nut 140 and neck of the port 120.

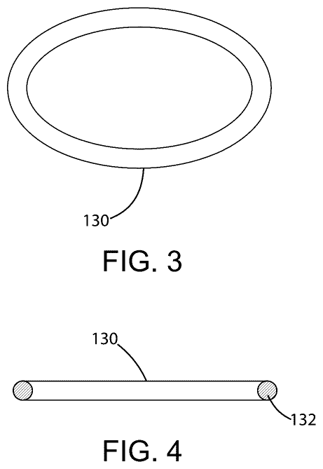

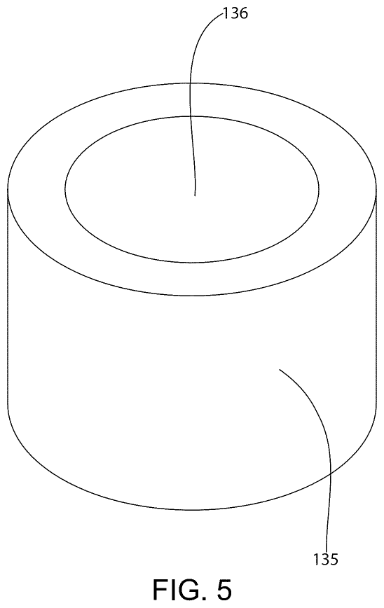

To provide a fluid-tight seal between the base 120 and the port 150 while still allowing fluid communication between the adapter port 105 and the received port 150, a seal, such as an O-ring 130, is disposed between the open end of port 150 and the top of the base 120. As shown in FIGS. 3 and 4, the O-ring 130 may, for example, be an elastomeric toroid, such as a torus, defined by rotating a disc 132 around an axis of revolution to define a ring shape. The O-ring may be comprised of any suitable elastomer, such as, but not limited to, rubber, silicone, Buna-N, or EPDM. The O-ring 130 may be compressed when the nut 140 is tightened to the base 120. Seals having other configurations and shapes may be used without departing from the scope of the invention.

A spacer 135 may be provided between the tubular tip of the received port 150 and the base 120. The spacer 135 maintains central alignment of the received port 150 within the base 120. The spacer 135 is a tubular component with a central channel having an inner diameter that is about equal to or slightly larger than the outer diameter of the tubular tip of the received port 150. The spacer 135 has an outer diameter that is about equal to or slightly less than the inner diameter of the base 120.

In an alternative embodiment, in lieu of the threads formed directly on the exterior of the adapter body, a separate component, such as a ring, may feature threads. The ring may be sized to snugly surround a portion of the outer surface of the adapter body. The ring may be removable. A tubular feature with threads may be integrally formed with and extend from the ring. The threads allow a nut or other component with mating threads to threadedly engage the ring.

The adapter port 105 contains a valve core 110. The valve core 110 controls flow through the adapter port 105. An exemplary valve core 110 is a poppet valve assisted by a spring. Using an appropriate tool, a valve core can be extracted from the port and, if necessary, replaced. In one embodiment, the valve core of the received port 150 is removed (and not replaced) before the port adapter 100 is installed.

In other embodiments, the valve core 110 may be coupled to valve core in the received port 150. The coupling may comprise a rigid connection between the valve stem of the core 110 and the core in the received port 150. In such an embodiment, actuation of the core 110 simultaneously causes actuation of the core in the received port 150.

In use, a port adapter 100 according to principles of the invention provides a fluid coupling between an adapter port 105 and a received port 150. The system on which such an adapter is used, may be serviced using the adapter port 105. Where the adapter port is an R-1234yf port, the system may be serviced using R-1234yf refrigerant. In such an embodiment, the received port 150 may be an R-134a port, or some other type of port.

An adapter according to principles of the invention may also be used to provide a new functional port 105 in place of a damaged port 150. A port may be internally damaged, such as by scratching from a tool. The adapter 100 provides a substitute port 105.

In all embodiments, the adapter port 105 is implemented (i.e., made functional) without removal and replacement of the received port 150. Removal and replacement are not only tedious and costly, but can be tricky, prone to leaks. Avoiding removal and replacement is extremely advantageous, saving time, materials and cost and reducing risks of leaks.

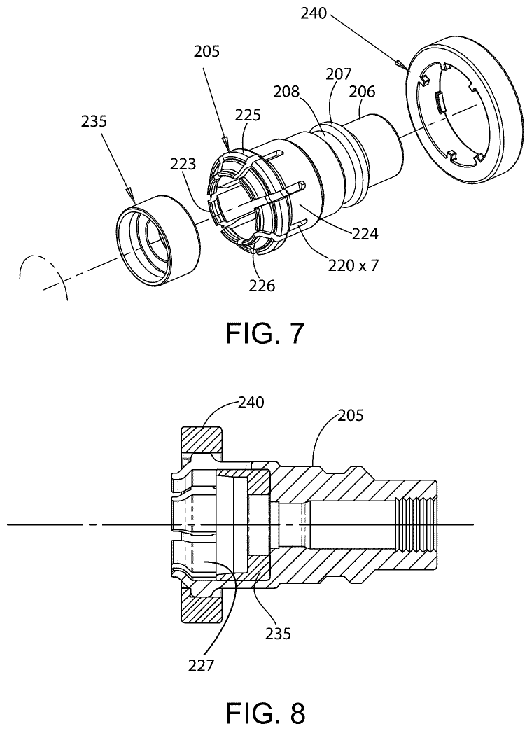

Referring to FIGS. 7 and 8, an alternative embodiment of a refrigerant port adapter according to principles of the invention excludes the threaded retainer (i.e., threads 125 and nut 140). In lieu of threaded retention, the adapter body 205 is contoured to grip a reduced diameter neck at the base of the received port 150, while a retaining ring 240 prevents removal. The adapter body can be divided into two sections—the engagement section in which a portion of the received port 150 is received and the valve section in which a valve core 110 is contained. As shown in FIG. 13, the valve section is internally threaded 204 to threadedly receive a valve core 110. The engagement section includes a compartment for receiving a seal 235 and a portion of the received port 150, with a leading edge defined by a chamfer 215 or fillet and tip 223 configured to abut the neck 151 (FIG. 1) of a received port 150. The neck 151 of the received port 150 is a portion of reduced diameter.

A plurality of longitudinal grooves 220 divides the engagement section into a plurality of fingers 224. Each finger 224 is a structure between immediately adjacent grooves 220. The grooves may be evenly spaced apart and parallel. By way of example and not limitation, 7 evenly spaced grooves 220 are shown in FIGS. 7, 8, 12 and 13. The grooves 220 may extend from the open end 226 of the engagement section to a terminus 219 at a point past the annular collar 225, but before the valve section. The terminus 219 may be rounded (radiused) with a radius of about ½ the width of the groove 220. The fingers 224 defined by the grooves exhibit flexibility. Deflection of the fingers 224 allows the engagement section to receive a portion of a port with features having an outer diameter that is greater than the inner diameter of the adapter 205 at the open end 226. As evident in FIG. 8, the inner diameter of the interior space 227 beyond the leading edge of the open end 226 exceeds the inner diameter at the leading edge of the open end 226 when the fingers 224 are not deflected apart.

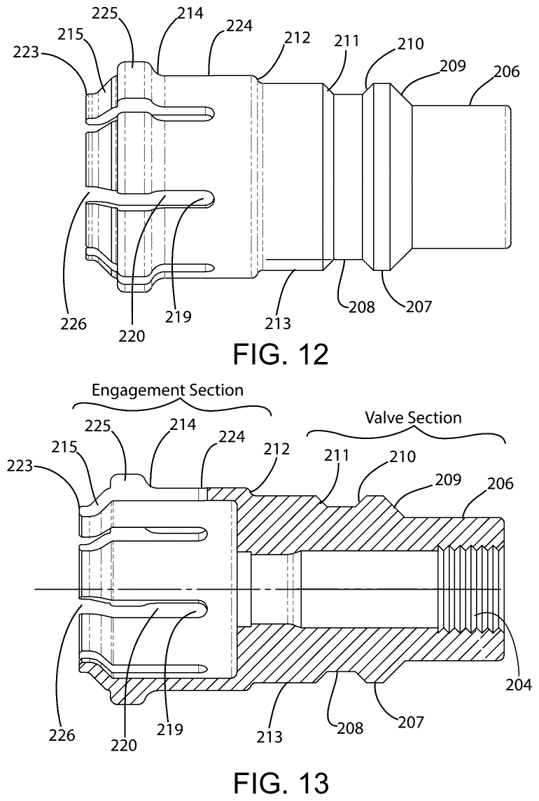

With reference to FIGS. 12 and 13, the collar 225 is an exterior ring-like structure forming an annular protrusion of the body 205. A radiused fillet (concave junction) 214 couples the collar to the waist section 224. Collar 207 is configured to engage a quick connect coupling, while collar 225 is not. Instead collar 225 is configured to engage retaining ring 240. A concave or sloped (angled) transition 215 extends from the tip 223 to the collar 225.

An intermediate section 213 joins the engagement section to the valve section. The intermediate section provides clearance for an installed valve 110. The clearance allows the valve 110 ample space for operation.

Exterior features of the engagement section provide the structure of a male quick connect coupling, more specifically, a male quick connect coupling for a R-1234yf refrigerant port. The exterior features may be configured (sized, shaped and positioned) for either a high-pressure side or a low-pressure side port. The features include an annular groove 208 between opposed chamfers 210 and 211, and between the intermediate section 213 and annular collar 207. The distal end 206 of the valve section is tubular with a consistent exterior diameter. Thus, the valve section may be coupled to conventional R-1234yf refrigerant service equipment using conventional couplings.

The interior of the distal end is threaded 204 for threadedly receiving a valve core 110. The valve core 110 is a valve assembly that threads into the distal end. The valve core 110 is a poppet valve assisted by a spring. Using an appropriate tool, a valve core can be extracted from the port and, if necessary, replaced. In one embodiment, the valve core of the received port 150 is removed (and not replaced) before the port adapter is installed.

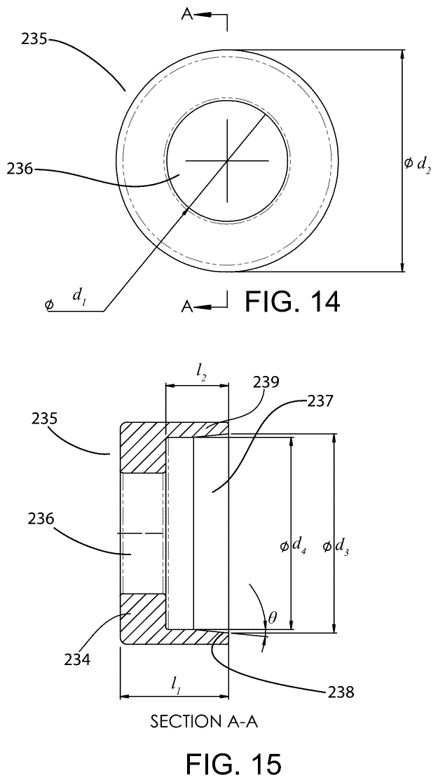

With reference to FIGS. 14 and 15, the seal 235 is a cup-shaped structure with a central aperture 236 through its base 234 and a sidewall 239 extending (like an annular flange) from the base 234. The seal 235 is installed in the interior compartment of the engagement section of the body 205. A portion of a received port 150 extends into the interior compartments and the seal 235. The seal 235 provides a fluid-tight joint between the interior of the engagement section of the adapter body 205 and the received portion of a received port 150.

The seal 235 is comprised of a resilient elastomer, such as, but not limited to, 70 durometer hydrogenated nitrile. Other elastomers that may be used for a seal include other Nitrile (NBR) compounds; Ethylene-Propylene Diene Monomer (EPDM); silicone rubber; neoprene, which is polychloroprene, a family of synthetic rubbers that are produced by polymerization of chloroprene; and Fluorine Kautschuk Material (FKM), which is a family of fluorocarbon-based fluoroelastomer materials defined by ASTM International standard D1418, and ISO standard 1629 and commonly called fluorine rubber or fluoro-rubber, with Viton® being a well-known brand. The seal may be compressed by squeezing to reduce its size to fit in the engagement section through the open end 226 of the body 205.

In one embodiment, the interior surface of the sidewall 239 at the free end of the seal 235 is angled (θ) to provide a slightly wider entry point for a received portion of the received port 150. With reference to FIGS. 14 and 15, to provide sealing against the free (open) end of the received port 150, diameter d₁ is less than the outer diameter of the free (open) end of the received port 150. To provide sealing against the interior of the engagement section of the body 205, diameter d₂ is preferably slightly greater than the interior diameter of the engagement section in which the seal 235 is received. To provide sealing against the received portion of the received port 150, diameter d₄ is preferably slightly less than the exterior diameter of the received portion of the received port 150. To facilitate entry of the received portion of the received port 150, diameter d₃ is slightly greater than diameter d₄.

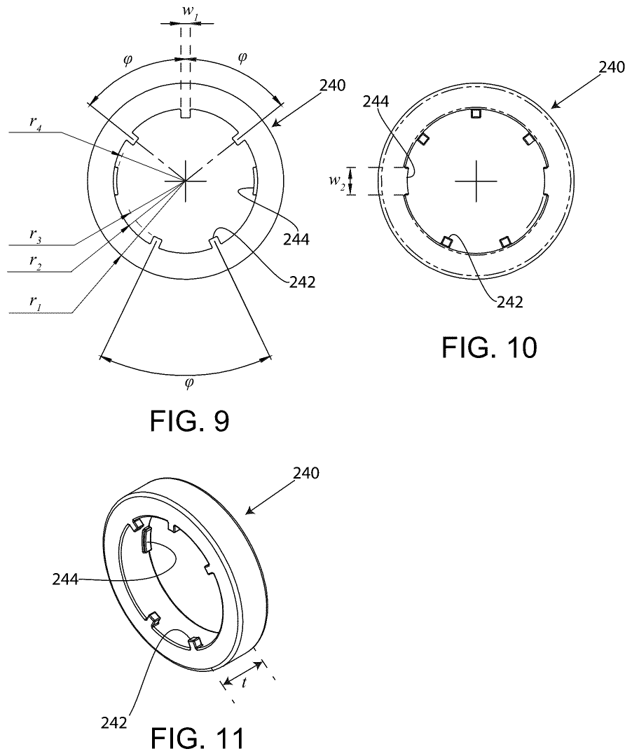

FIGS. 9 through 11 conceptually illustrate an exemplary retaining ring for the refrigerant port adapter of FIG. 6 according to principles of the invention. The retaining ring 240 is a ring-shaped structure with a proximal side and a distal side. The thickness t of the ring 240 exceed the width of the collar 225. The thickness t of the ring 240 is sufficient to allow a distance between groove tabs 242 and stop tabs 244 that exceeds the width of the collar 225.

A plurality of tabs 242 (i.e., groove tabs) extend radially from the interior surface at the proximal side of the ring 240. Each such tab 242 has a width w₁ that is not greater than (i.e., is equal to or less than) the width of a groove 220. The tabs 242 are located to align with grooves. Thus, the angle φ may be the same as the angle between adjacent grooves 220. During installation of the retaining ring 240, each tab 242 moves (slides) linearly through at least a portion of a groove 220 as the ring 240 is advanced over the collar 225. The invention does not require such a tab 242 for each groove 220. At least two tabs 242 are preferred. Five such tabs 242 are shown in the exemplary embodiment, each of which is positioned for alignment with a groove 220.

Another plurality of tabs 244 (stop tabs) extend radially from the interior surface at the proximal side of the ring 240. Each such tab 244 has a width w₂ that is greater than the width of a groove 220. The tabs 244 are located to align with fingers, while the groove tabs 242 align with grooves 220. The invention does not require such a tab 242 for each finger 224. At least two stop tabs 244 are preferred. Two such tabs 244 are shown in the exemplary embodiment, each of which is positioned for alignment with a finger 224, such fingers 224 being 180° apart.

During installation of the retaining ring 240, the groove tabs 242 are positioned on one side of the collar 225 while the stop tabs 244 are positioned on the other side of the collar 225. The groove tabs may slide through grooves 220 that extend through the collar 225. The stop tabs 244 are too wide to slide through the grooves 220, and are not positioned to align with the grooves 220 when the groove tabs 242 align with the grooves 220. Thus, the stop tabs 244 limit linear movement of the ring along the body 205. When the stop tabs 244 abut the collar 225, further linear movement toward the open end 226 is resisted. At that point, the ring 240 may be rotated (e.g., a half turn, i.e., 180°). The groove tabs 242 do not extend into the grooves in the recessed chamfer region 215 and, therefore, do not resist rotation. After such rotation, the groove tabs 242 may no longer align with the grooves 220. This arrangement resists removal of the ring 240. After such rotation, each stop tab 244 may overlap a groove and portions of adjacent fingers.

The ring 240 is sized for a snug fit on the collar 225. The inner radius r₂ is about equal to the outer radius of the collar 225. The outer radius r₁ is sufficiently greater than the inner radius r₂ to provide adequate material for structural integrity and ease of handling the ring 240. The radius r₃ from the free end of each groove tab 242 to the center is greater than the outer diameter of the body 205 at the recessed chamfer region 215, to allow rotation, but less than the outer diameter at the collar 225. The radius r₄ from the free end of each stop tab 244 to the center is about equal to (not less than) or slightly greater than the outer diameter of the body 205 at the waist section 224, but less than the outer diameter at the collar 225.

Unlike the elastomeric seal 235, the ring 240 and body 205 are preferably comprised of durable rigid materials. By way of example and not limitation, the ring 240 may be comprised of aluminum, e.g., 6061-T6 aluminum, while the body 205 may be comprised of brass, e.g., brass C36000 H-02 with nickel plating.

A portion of a port 150 received in the engagement section has quick connect structural features, including a collar with a diameter greater than the diameter of the open end 226. The portion of the port 150 is received in the engagement section by deflecting the fingers outwardly, thus temporarily expanding the diameter at the open end 226. As the collar of the received portion of the port 150 includes chamfered sides, urging the open end 226 of the adapter body 205 against the received portion of the port 150 will cause the fingers 224 to deflect outwardly. When the received portion of the port 150 is seated in and against the seal 235 in the engagement section, the fingers 224 are no longer deflected outwardly. When the ring 240 is installed on the collar 225, outward deflection of the fingers 224 is prevented. Thus, the portion of the port 150 received in the engagement section cannot be removed when the ring 240 is installed on the collar 225.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function, and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A refrigerant port adapter comprising:
an adapter body, the adapter body including a valve section and an engagement section, the engagement section configured to receive at least a portion of a first refrigerant port, the engagement section containing a valve core, the valve section including an exterior configured for quick connect coupling and valve core actuation;
a resilient seal contained in the engagement section, the seal being shaped and sized to provide a fluid-tight seal between the engagement section and the first refrigerant port;
a retainer engaging at least a portion of an exterior of the engagement section, the retainer preventing removal of the adapter body from the first refrigerant port.

2. The refrigerant port adapter of claim 1, the retainer comprising a nut and threads provided on an exterior surface of the adapter body.

3. The refrigerant port adapter of claim 2, wherein the threads are formed on a ring surrounding an exterior surface of the adapter body.

4. The refrigerant port adapter of claim 1, the engagement section including an open end, a plurality of spaced apart grooves extending from the open end and defining fingers therebetween, the fingers being flexible outwardly, and the retainer comprising a ring that is moveable relative to the adapter body, and in an installed position the ring surrounds a portion of the fingers and prevents outward deflection of the fingers.

5. The refrigerant port adapter of claim 4, the exterior of the engagement section including a protruding collar, each groove of the plurality of spaced apart grooves extending from the open end to a terminus, the collar being disposed between the open end and the terminus, and the ring being sized and shaped to tightly surround the collar.

6. The refrigerant port adapter of claim 5, the plurality of spaced apart grooves being evenly spaced apart.

7. The refrigerant port adapter of claim 6, the plurality of spaced apart grooves being at least five grooves.

8. The refrigerant port adapter of claim 7, the plurality of spaced apart grooves being at least seven grooves.

9. The refrigerant port adapter of claim 6, the ring including a plurality of spaced apart groove tabs, each groove tab extending radially inwardly and being sized, shaped, and located to align with and move slidingly within one of the grooves of the plurality of spaced apart grooves.

10. The refrigerant port adapter of claim 9, the number of groove tabs not exceeding the number of grooves of the plurality of spaced apart grooves.

11. The refrigerant port adapter of claim 10, the number of groove tabs being at least 5.

12. The refrigerant port adapter of claim 9, the ring further comprising a plurality of stop tabs, the stop tabs being spaced apart from the groove tabs, and the stop tabs impeding sliding movement of the ring beyond the collar.

13. The refrigerant port adapter of claim 12, the number of stop tabs of the plurality of stop tabs being 2.

14. The refrigerant port adapter of claim 12, the plurality of stop tabs being evenly spaced apart.

15. The refrigerant port adapter of claim 12, each stop tab of the plurality of stop tabs being angularly aligned between adjacent groove tabs.

16. The refrigerant port adapter of claim 1, the fluid-tight seal being cup-shaped and having a central aperture.

17. The refrigerant port adapter of claim 1, the fluid-tight seal including a base and a sidewall, the sidewall being an annular flange extending from the base, the central aperture being formed in the base.

18. The refrigerant port adapter of claim 17, the central aperture having a diameter that is less than a diameter of an end of the portion of the first refrigerant port.

19. The refrigerant port adapter of claim 18, the central aperture having a diameter that is less than a diameter of an end of the portion of the first refrigerant port.

20. The refrigerant port adapter of claim 19, the sidewall including a free end defining an opening, an internal diameter at the opening being greater than an internal diameter of the sidewall adjacent to the base.
